(19) United States
(12) Patent Application Publication
(10) Pub. No.: US 2026/0155770 A1
(43) Pub. Date: Jun. 4, 2026

(54) CASCADED H-BRIDGE (CHB) CONVERTER FOR MEDIUM-VOLTAGE (MV) SRM DRIVES

(71) Applicant: ENEDYM INC., Hamilton (CA)

(72) Inventors: Nasir Ali, Hamilton (CA); Mehdi Narimani, Oakville (CA)

(21) Appl. No.: 19/403,507

(22) Filed: Nov. 28, 2025

Related U.S. Application Data
(60) Provisional application No. 63/726,341, filed on Nov. 29, 2024.

(51) Int. Cl. H02P 27/06; H02K 1/14; H02K 1/24

(52) U.S. Cl. CPC H02P 27/06; H02K 1/14; H02K 1/246; H02P 2207/05; H02P 2209/05

(57) ABSTRACT

Embodiments herein generally relate to several converter topologies for driving a switched reluctance motor (SRM) and methods of operating the same. In at least one embodiment, a cascaded H-bridge (CHB) converter system for driving a SRM with m number of phases is disclosed. The system comprises a plurality of cells arranged into m phase legs, where each phase leg comprises a predetermined number (n) of cells cascaded in series, where n is greater than or equal to 1, and wherein each phase leg corresponds to a respective phase winding of the SRM; each cell comprising a plurality of switching elements and a corresponding DC voltage supply; and a controller configured to selectively control the switching elements of the cascaded cells of each phase leg to produce, at an output of the corresponding phase leg, a plurality of discrete phase voltage levels for operating the SRM in a plurality of operating modes, wherein the number of discrete phase voltage levels provided by each phase leg equals 2n+1. In at least one other embodiment, a CHB converter system comprising at least two phase legs sharing one or more of the cells, where the shared cells are associated with phases that are not conducted simultaneously during any commutation interval is disclosed.

### CROSS-REFERENCE TO RELATED APPLICATION(S)

This application claims the benefit of U.S. Provisional Patent Application No. 63/726,341 filed Nov. 29, 2024 entitled “CASCADED H-BRIDGE (CHB) CONVERTER FOR MEDIUM-VOLTAGE (MV) SRM DRIVES”. The contents of U.S. Provisional Patent Application No. 63/726,341 are hereby incorporated herein by reference in its entirety.

### FIELD

The present disclosure generally relates to power electronics for motor drive systems, and more particularly to converter topologies for medium voltage switched reluctance motor (SRM) drives.

### INTRODUCTION

The following is not an admission that anything discussed below is part of the prior art or part of the common general knowledge of a person skilled in the art.

Switched reluctance motors (SRMs) present a simple and robust configuration, with concentrated windings around the stator poles and a rotor composed entirely of laminated silicon steel. Both the stator and rotor have salient poles, which contribute to high output torque, while the absence of rotor windings or permanent magnets allows operation at high speeds and temperatures with reduced losses. These features make SRMs an attractive alternative to traditional permanent magnet machines for low-to medium-voltage industrial applications.

A typical SRM drive system includes the motor, a power converter, position and current sensors, and a digital controller. The sensors provide feedback for closed-loop operation, and standard converter topologies such as two-level asymmetric half-bridge (AHB) converters are widely used to regulate phase currents. Soft-switching strategies are often employed to reduce torque ripple and switching losses.

While conventional two-level and multilevel converters improve SRM performance, they are generally not scalable for medium-voltage applications and fail to provide the flexible output voltage and power range required for industrial use. Many applications demand high-power converters. However, common industrial converter topologies, including neutral-point clamped (NPC), flying capacitor, and cascaded H-bridge (CHB) converters, which have primarily been developed for AC machines, often involve a large number of power switches and permanent magnets, limiting cost-effectiveness and reliability.

Accordingly, there is a need for a SRM drive system capable of providing reliable, efficient and cost-effective operation in medium-voltage industrial environments.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In various embodiments disclosed herein, there is provided a method for development of a topology for utilizing the commercially available cascaded H-bridge (CHB) converters for medium voltage switched reluctance motor drives consisting of a fault tolerant operation.

In various embodiments disclosed herein, there is provided a control strategy of the medium voltage (MV) SRM drives based on CHB converter, which is a cost-effective and high reliability solution for MV industries.

In various embodiments disclosed herein, there is provided a multi-level converter topology for a m-phase switched reluctance machine (SRM), comprising: A plurality of power cells arranged in a 2n+1-level Cascaded H-Bridge (CHB) configuration, where ‘n’ represents the number of cells and ‘m’ represents the number of phases of the SRM.

In various embodiments, the converter topology disclosed herein offers improved performance, reliability, and adaptability in generating multilevel voltages for the multiphase MV SRM.

In various embodiments disclosed herein, there is provided a cost-effective shared-cell CHB based topology for a four-phase MV SRM comprising: cascaded H-bridges to generate desired level of voltages where the upper power cells are shared among two phases to reduce the number of power cells, and the associated cost.

In various embodiments, the control scheme of the shared power cell topology offers high performance without a significant cost and size reduction.

In various embodiments disclosed herein, at least two CHB topologies for MV SRMs are provided.

In various embodiments disclosed herein, there is provided a CHB configuration, where a multitude of power cells is strategically arranged in a 2n+1-level structure, with ‘n’ denoting the number of cells and ‘m’ signifying the number of phases in the SRM. In various embodiments, each power cell is equipped with a four-pack switch module, incorporating four controllable switches and associated diodes. In various embodiments, the modular construction enables a cascading arrangement of power cells, facilitating the generation of multilevel output voltages meticulously tuned to the unique requirements of medium voltage (MV) SRMs.

In various embodiments disclosed herein, there is provided a shared power cell CHB topology suitable for a four-phase MV SRM. In various embodiments, in a four phase MV SRM, phase A and phase C share the same power cells, while phase B and phase D share their upper power cells. In various embodiments, this approach significantly reduces the switch counts, and the required isolated dc-sources providing a low-cost solution without limiting the flexibility and scalability features of the CHB topology. In various embodiments, the converter can be operated efficiently at any voltage level above 2.3 kV, as permitted by the targeted MV SRM.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments but should be given the broadest interpretation consistent with the description as a whole.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is a schematic diagram of a conventional three-phase 12/8 SRM, in accordance with an example.

FIG. 1B is a schematic diagram of a SRM drive system, in accordance with an example.

FIG. 2 is a schematic diagram of a conventional asymmetric half-bridge (AHB) converter for SRM drives, in accordance with an example.

FIG. 3A is a schematic diagram of a conventional AHB converter in one mode of operation, in accordance with an example.

FIG. 3B is a schematic diagram of a conventional AHB converter in another mode of operation, in accordance with an example.

FIG. 3C is a schematic diagram of a conventional AHB converter in a further mode of operation, in accordance with an example.

FIG. 4 is a schematic diagram of a CHB-based MV SRM drive for a m-phase SRM, in accordance with an example.

FIG. 5 is a graph showing simulation waveform for a CHB-based MV SRM drive, in accordance with an example.

FIG. 6 is a graph showing simulation waveform for a CHB-based MV SRM drive, in accordance with another example.

FIG. 7 is a schematic diagram of a CHB-based MV SRM drive for a m-phase SRM, in accordance with another example.

FIG. 8 is a schematic diagram of a CHB-based MV SRM drive for a m-phase SRM, in accordance with a further example.

FIG. 9 is a schematic diagram of a CHB-based MV SRM drive for a m-phase SRM, in accordance with an example.

FIG. 10 is a schematic diagram of a CHB-based MV SRM drive for a m-phase SRM, in accordance with an example.

FIG. 11A is a schematic diagram of a CHB-based MV SRM drive for a m-phase SRM in a fault condition, in accordance with an example.

FIG. 11B is a schematic diagram of a CHB-based MV SRM drive for a m-phase SRM in a fault condition, in accordance with another example.

FIG. 12 is a schematic diagram of a current chopping control for SRM drives, in accordance with an example.

FIG. 13 is a graph showing simulation waveform for a CHB-based MV SRM drive, in accordance with an example.

FIG. 14 is a graph showing simulation waveform for a CHB-based MV SRM drive, in accordance with another example.

FIG. 15 is a graph showing simulation waveform for a CHB-based MV SRM drive, in accordance with a further example.

FIG. 16 is a graph showing simulation waveform for a CHB-based MV SRM drive, in accordance with another example.

FIG. 17 is a graph showing simulation waveform for a CHB-based MV SRM drive, in accordance with an example.

FIG. 18 is a graph showing simulation waveform for a CHB-based MV SRM drive, in accordance with another example.

FIG. 19 is a graph showing simulation waveform for a CHB-based MV SRM drive, in accordance with a further example.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

It should also be noted that the terms “coupled” or “coupling” as used herein can have several different meanings depending in the context in which these terms are used. For example, the terms coupled or coupling can have a mechanical, fluidic or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore, coupled electrical elements may send and/or receive data.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof. In effect, this term means that “at least one of” or “one or more” of the listed items is used or present.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies. In addition, all ranges given herein include the end of the ranges and also any intermediate range points, whether explicitly stated or not.

In embodiments comprising an “additional” or “second” component, the second component as used herein is chemically different from the other components or first component. A “third” component is different from the other, first, and second components, and further enumerated or “additional” components are similarly different.

These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Exemplary communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The abbreviation, “e.g.” is derived from the Latin exempli gratia and is used herein to indicate a non-limiting example. Thus, the abbreviation “e.g.” is synonymous with the term “for example.” The word “or” is intended to include “and” unless the context clearly indicates otherwise.

It will be understood that any component defined herein as being included may be explicitly excluded by way of proviso or negative limitation, such as any specific compounds or method steps, whether implicitly or explicitly defined herein.

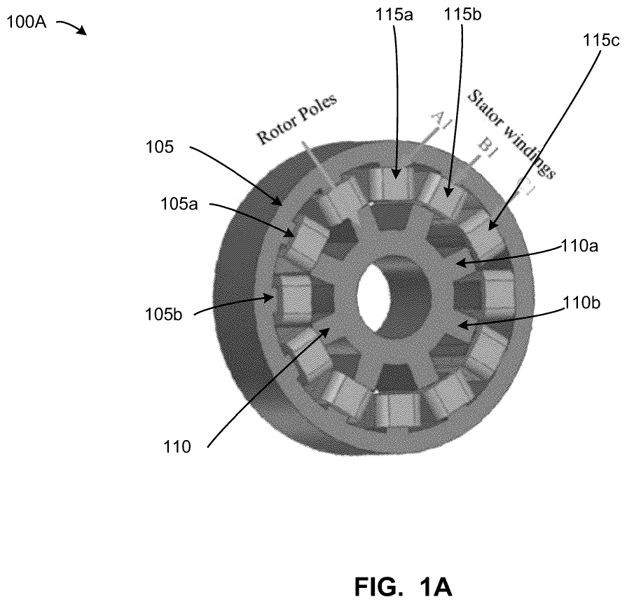

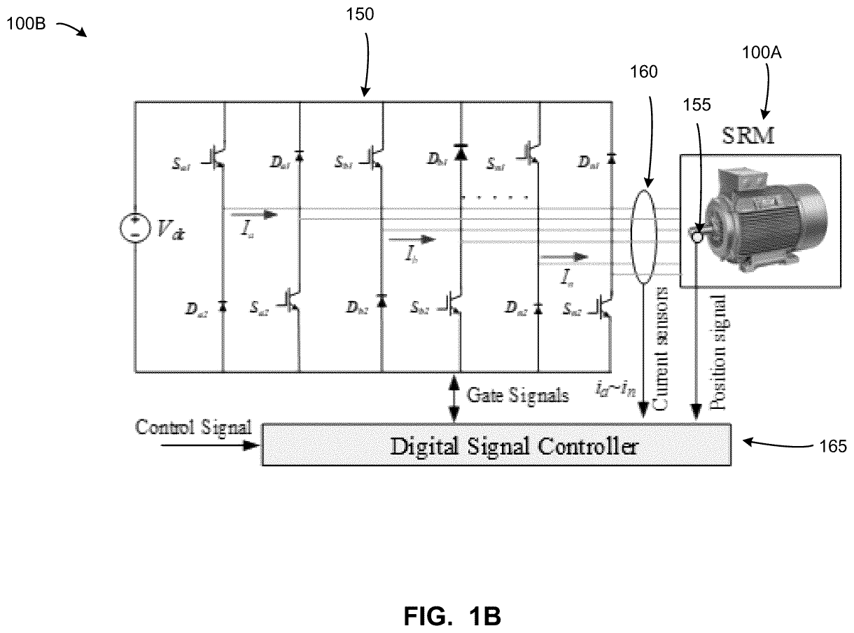

Reference is made to FIG. 1A, which illustrates a cross-sectional view 100A of a switched reluctance motor (SRM) in accordance with an example embodiment. The illustrated SRM 100A has a stator 105 and a rotor 110 located within the stator 105, where both the stator 105 and the rotor 110 have salient poles, which contribute to producing high output torque. In the illustrated embodiment, the stator 105 comprises 12 stator poles. Stator poles 105a and 105b are shown herein as examples. The rotor 110 comprises 8 rotor poles, and rotor poles 110a and 110b are shown herein as examples. The illustrated SRM is a three phase 12/8 SRM.

The SRM 100A further comprises concentrated windings only around the stator poles, such as, for example, a first phase winding 115a, a second phase winding 115b and a third phase winding 115c. The absence of windings or a permanent magnet on the rotor 110 allows the SRMs to work at very high speeds, and under high temperatures, and also reduces the overall losses. In the illustrated embodiment, the SRM presents a simple and robust configuration. The rotor 110a is purely made of a stack of silicon steel, and silicon steel lamination on both the stator 105 and the rotor 110 largely reduces the eddy currents. Therefore, SRMs are considered as an attractive alternative to the traditional permanent magnet machines for low to medium voltage industrial applications.

Reference is next made to FIG. 1B, which illustrates a block diagram of a SRM drive system 100B in accordance with an example embodiment. The SRM drive system 100B includes an SRM 100A, a power converter 150, a position sensor 155, a current sensor 160, and a digital controller 165. The position sensor 155 is used for generating position feedback signals from the SRM to the digital controller 165, and the current sensor 160 is used for generating current feedback signals to the digital controller 165. The sensors enable closed-loop operation of the SRM by, for example, allowing the controller 165 to monitor rotor position and phase currents in real time, ensuring accurate commutation, stable torque production, and safe operation.

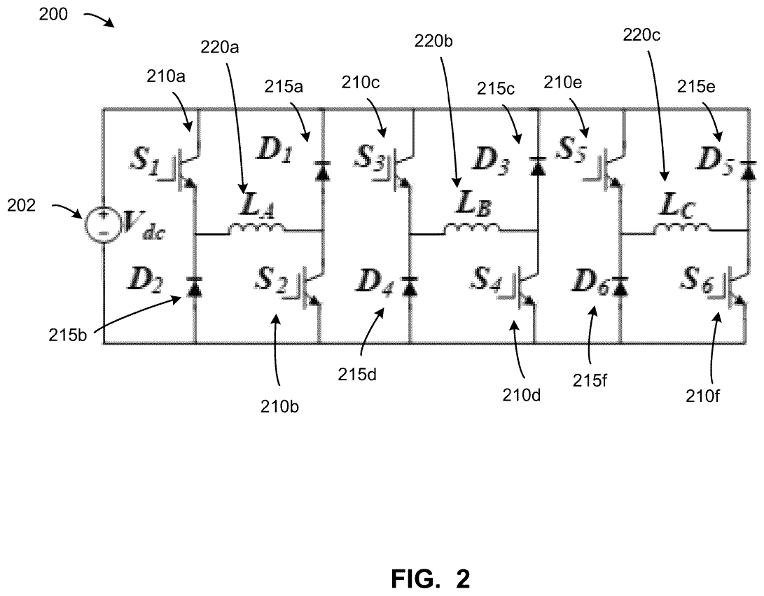

Reference is made to FIG. 2, which illustrates a power converter 200 forming part of a SRM drive in accordance with an example embodiment. Power converter 200 is analogous to power converter 150 of FIG. 1B. The illustrated power converter 200 is a two-level asymmetric half-bridge (AHB) converter. In the illustrated embodiment, the two-level AHB converter 200 includes a DC voltage source 202, plurality of switches, including a first switch 210a, a second switch 210b, a third switch 210c, a fourth switch 210d, a fifth switch 210e and a sixth switch 210f. The AHB converter 200 further comprises a plurality of diodes, including a first diode 215a, a second diode 215b, a third diode 215c, a fourth diode 210d, a fifth diode 210e and a sixth diode 210f.

In the illustrated embodiment, the switches 210a-210f and diodes 215a-215f are interconnected to form three asymmetric half-bridge phase legs, each corresponding to one phase of the SRM. Each phase leg comprises two power switches and two freewheeling diodes, where each phase leg sub-circuit is coupled in parallel to the DC voltage source 202 and other phase leg sub-circuits.

The illustrated AHB converter further includes a first inductive element 220a representing the first phase winding, a second inductive element 220b representing the second phase winding and a third inductive element 220c representing the third phase winding. The phase windings are placed in series to the two power switches in each phase leg. For example, the first phase winding 220a is placed in series with a first power switch 210a and a second power switch 210b.

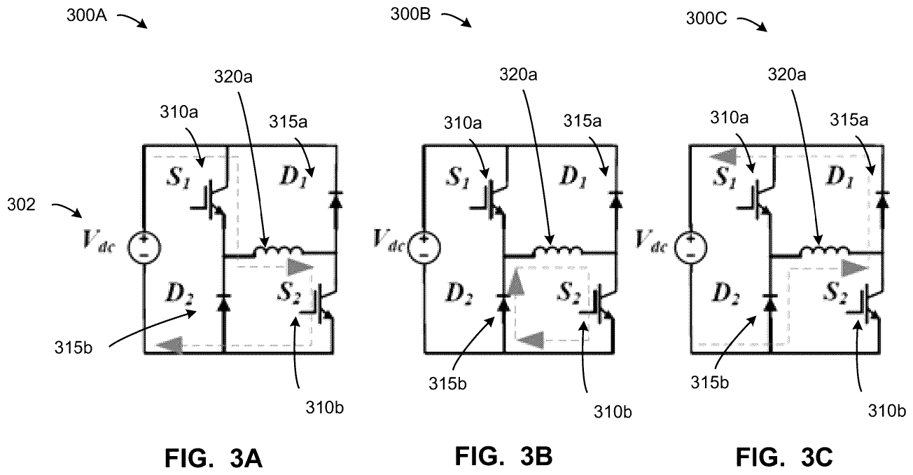

The AHB converter 200 can operate in three modes of operation during a single electrical period, as illustrated with reference to a phase leg in FIGS. 3A-3C. FIG. 3A illustrates a magnetization mode topology 300A of a phase leg, FIG. 3B illustrates a freewheeling mode topology 300B of the phase leg and FIG. 3C illustrates a demagnetization mode topology 300C of the phase leg. DC voltage source 302, a first switch 310a, a second switch 310b, a first diode 315a, a second diode 315b, and a first inductive element 320a of FIGS. 3A-3C are analogous to the DC voltage source 202, the first switch 210a, the second switch 210b, the first diode 215a, the second diode 215b, and the first inductor 220a of FIG. 2. Referring again to FIG. 2, the soft-switching strategy is normally adopted for phase current regulation, in which the upper power switches, such as the first switch (S1) 210a, the third switch S3 (210c) and the fifth switch (S5) 210e, chop while the lower switches, such as the second switch (S2) 210b, the fourth switch (S4) 210d and the sixth switch (S6) 210f are closed during the phase turn-on region. This switching strategy greatly helps in reducing the ripple torque and switching losses.

Typically, standard two-level AHB converter topologies provide cost reduction, efficiency improvement and fault-tolerance for the SRM drive systems. However, AHB converters do not meet the performance requirements for high speed and high torque applications. Several advanced power converters for SRMs have been investigated for SRM's performance improvements. In these converters, multilevel voltages are produced to achieve high magnetization, and demagnetization for high-speed applications. The multilevel voltages are generated by adding redundant active and passive components to the conventional AHB and neutral point clamped converter (NPC). The multilevel converters are effective for performance improvements particularly at high-speed operation compared to the two-level counterparts. However, the existing two-level and multilevel converters in SRM drives are not feasible for medium voltage applications. They are not scalable to achieve flexible output voltage and power range required for medium voltage (MV) industrial applications.

In order to use the SRMs for MV applications including pipeline pumps in the petrochemical industry, fans in the cement industry, pumps in water pumping stations, traction applications in the transportation industry, steel rolling mills in the metals industry, and other applications, a high-power converter is essentially required. Many topologies have been developed, among them, the neutral-point clamped (NPC), flying capacitor, and the cascaded H-bridge (CHB), are the most studied and commercialized by major manufacturers. Currently, these topologies cover a voltage and power range from 2.3 to 13.8 kV. In various cases, such topologies are proposed, and their feasibility studies are conducted based on alternating current (AC) machines, including permanent magnet synchronous motors (PMSMs) and induction motors (IMs). Nonetheless, the large number of power switches in the high-power converter, and the permanent magnets on the machine make them less efficient in terms of cost and reliability for industrial applications.

Since SRMs do not require permanent magnets and operate with unidirectional phase currents, their integration with cascaded H-bridge (CHB) converters provides several advantages over other AC machines, including improved cost-effectiveness and fault tolerance. Accordingly, a new CHB-based MV SRM drive system is disclosed herein, which offers a cost-effective and highly reliable solution for MV industrial applications.

### CHB-Fed MV SRM Drive

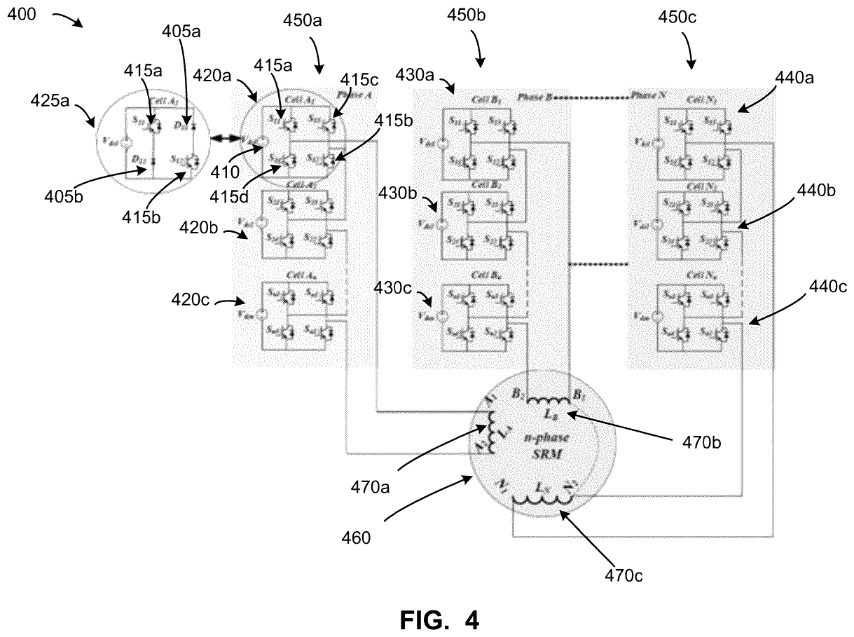

Reference is next made to FIG. 4, which illustrates a block diagram of a power converter 400 for a SRM drive, in accordance with an example embodiment. In the illustrated embodiment, power converter 400 shows a 2n+1-level CHB topology, which comprises n-cells per phase for driving an m-phase SRM. In the disclosure herein, ‘n’ represents the number of cells and ‘m’ represents the number of phases of the SRM.

As shown, the topology 400 comprises a m-phase SRM 460. The illustrated SRM 460 is shown to have a first phase winding 470a, a second phase winding 470b, . . . , and an m-th phase winding 470c, corresponding to the first, second, and m-th phases of SRM 460. Each phase leg of the SRM drive comprises ‘n’ cells cascaded together. For example, the first phase leg 450a comprises a first cell 420a, a second cell 420b and a n-th cell 420c. Similarly, the second phase leg 450b comprises a corresponding first cell 430a, a second cell 430b and a n-th cell 430c. The M-th phase leg 450c comprises a corresponding first cell 440a, a second cell 440b and a n-th cell 440c.

In various embodiments, each of the ‘n’ cells per phase, i.e. cells 420a-c, 430a-c and 440a-c, contains a four-pack switch module. For example, cell 420a comprises a first switch 415a, a second switch 415b, a third switch 415c and a fourth switch 415d, and a power source 410 connected in parallel to the four-pack switch module.

In some other embodiments, each phase leg 450a, 450b and 450c comprises cell 425a instead of 420a-c, 430a-c and 440a-c. Cell 425a comprises a first switch 415a, a second switch 415b, a first diode 405a and a second diode 405b, where the two switches and diodes are connected in an asymmetric half-bridge configuration. However, such a configuration may offer less fault-tolerance and tends to be more expensive compared to four-switched modular structure discussed above.

In the illustrated embodiment, the number of power cells and the desired number of output voltage level has the relation of 2n+1, where ‘n’ refers to the number of cells per phase and ‘2n+1’ represents the number of voltage levels. The CHB converter 400 is controlled through magnetization, freewheeling and demagnetization modes.

Traditionally, the current direction is SRMs are unidirectional as shown through the AHB converter in FIG. 3. With the CHB converter 400, the SRM can be rotated with bidirectional current flow as the output torque is independent of current direction in SRM drives. The CHB converter 400, accordingly, provides the benefit of extreme fault-tolerance capabilities. Firstly, due to the independent operation of the phases, a fault in one phase, in general, does not affect the other phases. Secondly, the two diagonal switches are utilized for normal operation, and the other two diagonal switches can be used as fault-tolerant auxiliary.

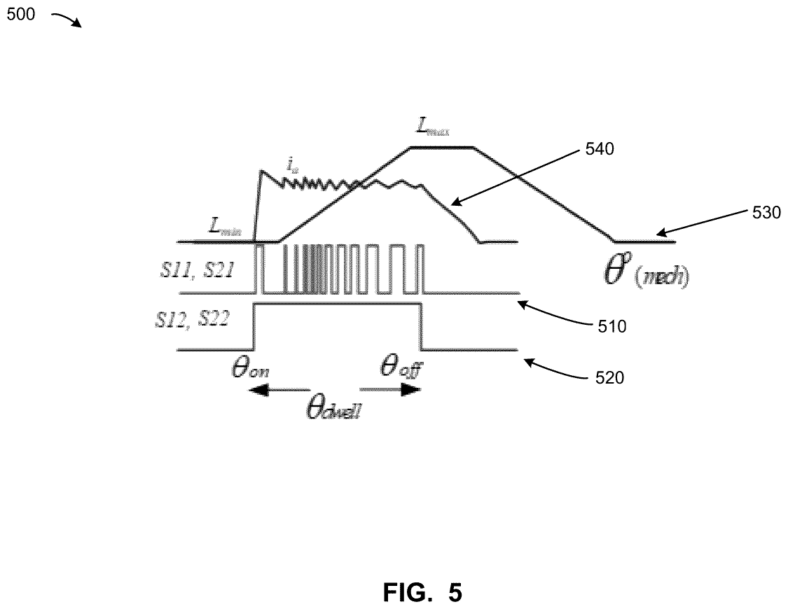

Reference is next made to FIG. 5, which illustrates example simulation waveforms 500 in accordance with an example embodiment. In particular, waveforms 500 include a first waveform 510 corresponding to switching signals for a subset of switches, a second waveform 520 corresponding to switching signals for another subset of switches, a third waveform 530 corresponding to phase inductance and fourth waveform 540 corresponding to a phase current, under soft-switching operation. The first waveform 510 particularly corresponds to switching signals for a first switch of a first cell (S11) in a phase leg and a first switch of a second cell (S21) in the same phase leg. The second waveform 520 particularly corresponds to switching signals for a second switch of a first cell (S12) in a phase leg and a second switch of a second cell (S22) in the same phase leg. As shown, during the inductance ascending region, one switch of the power cell keeps chopping while the other switch remains closed in the phase turn-on region. For example, in the inductance ascending region, the first switch of the first cell (S11) in a phase leg keeps chopping, whereas the second switch of the first cell (S12) remains closed in the phase turn-on region. The operating mode is called soft-switching operation, which is illustrated in FIG. 5.

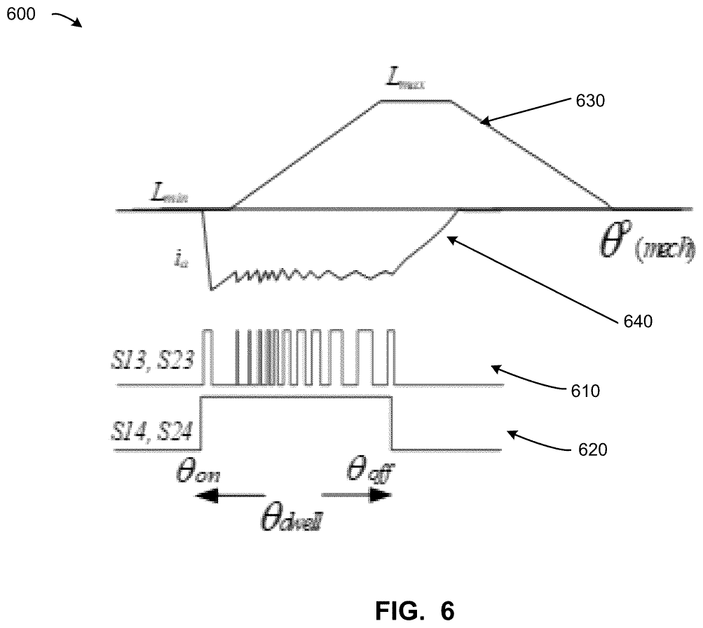

Reference is next made to FIG. 6, which illustrates example simulation waveforms 600 in accordance with an example embodiment. In particular, waveforms 600 include a first waveform 610 corresponding to switching signals for a subset of switches, a second waveform 620 corresponding to switching signals for another subset of switches, a third waveform 630 corresponding to phase inductance and fourth waveform 640 corresponding to a phase current, under soft-switching operation. The first waveform 610 particularly corresponds to switching signals for a third switch of a first cell (S13) in a phase leg and a third switch of a second cell (S23) in the same phase leg. The second waveform 620 particularly corresponds to switching signals for a fourth switch of a first cell (S14) in a phase leg and a fourth switch of a second cell (S24) in the same phase leg. Switches S13, S23, S14 and S24 are diagonally opposite to switches S11, S21, S12 and S22 of FIG. 5. As shown, during the inductance ascending region, one switch of the power cell keeps chopping while the other switch remains closed in the phase turn-on region. For example, in the inductance ascending region, the third switch of the first cell (S13) in a phase leg keeps chopping, whereas the fourth switch of the first cell (S14) remains closed in the phase turn-on region. The resulting current, as shown by waveform 640, flows in the opposite direction to achieve motor control. Under normal operation, the current direction does not affect the performance of the drive system.

During normal operation, bidirectional current excitation may be adopted alternatively in the two consecutive turn-on regions by fully utilizing the available switches. This alternating excitation allows the current burden to be shared among the switches, thereby distributing heat more evenly and facilitating improved heat-sink design.

In the event of a switch failure within a phase leg, the remaining healthy leg of the corresponding power cell can continue to provide current excitation, thereby maintaining motor drive operation.

Power converter 400 provides several advantages, such as, for example, topology 400 is modular, scalable and universal for m-phase SRMs. The power converter 400 can also be used for a wide range of output voltage ranges between 2.3 kV to 13.8 kV. Furthermore, CHB converter fed MV SRM drives can be operated above the base speed without compromising the performance of the drive system. This makes the SRM useful for very high-speed high-power applications. Compared to CHB fed other ac motor drives, the SRM drive system with CHB offers excellent fault-tolerance. The motor drive can continue operating without performance degradation even if the one set of diagonal switches in each power cell are in failure condition. The CHB fed MV SRM drives are cost-effective, and reliable compared to the CHB fed MV PM or induction motor drives.

### Case Study

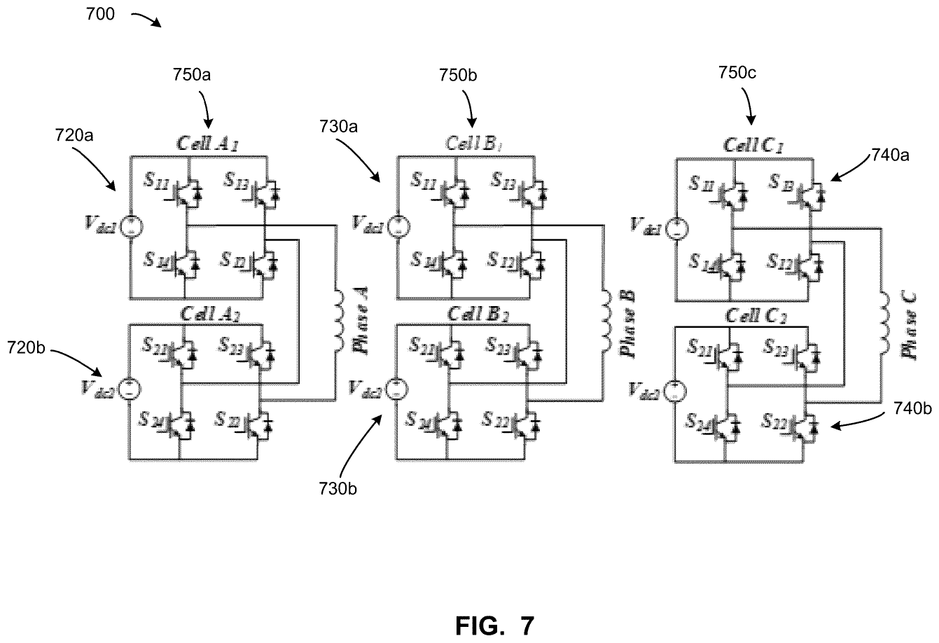

Reference is next made to FIG. 7, which illustrates a block diagram of a power converter 700 for a SRM drive, in accordance with an example embodiment. The illustrated power converter 700 is a CHB-based topology for MV SRM drives, and comprise two power cells in each phase and drives a three-phase SRM. In particular, the first phase leg 750a comprises a first cell 720a and a second cell 720b. The second phase leg 750b comprises a first cell 730a and a second cell 730b. The third phase leg 750c comprises a first cell 740a and a second cell 740b. The power converter 700 is a 5-level topology and is able to provide 5 voltage levels. The feasibility of the power converter 700 for medium-voltage (MV) switched reluctance motor (SRM) drives is validated using an SRM model implemented in MATLAB.

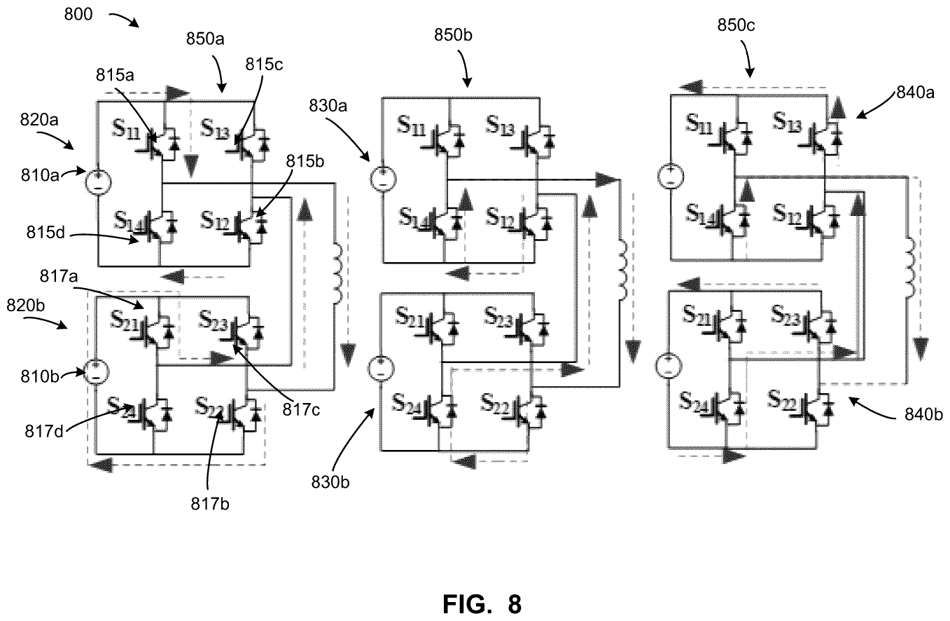

Reference is next made to FIG. 8, which illustrates a block diagram of a power converter 800 for a SRM drive, in accordance with an example embodiment. Power converter 800 is analogous to power converter 700 of FIG. 7, where phase legs 850a, 850b and 850c are analogous to phase legs 750a, 750b and 750c of FIG. 7. Cells 820a-b, 830a-b an 840a-b are analogous to cells 720a-b, 730a-b and 740a-b of FIG. 7. Cell 820a comprises a first switch (S11) 815a, a second switch (S12) 815b, a third switch (S13) 815c and a fourth switch (S14) 815d. Cell 820b comprises a first switch (S21) 817a, a second switch (S22) 817b, a third switch (S23) 817c and a fourth switch (S24) 817d. Table I shows an example switching table for the converter topology 800 of FIG. 8 for one phase leg (e.g., Phase A), in accordance with one example embodiment.

TABLE I
Switching table for the proposed CHB when
current flowing in positive direction

| S₁₁ | S₁₂ | S₁₃ | S₁₄ | S₂₁ | S₂₂ | S₂₃ | S₂₄ | Vₚₕ | Working mode |
|---|---|---|---|---|---|---|---|---|---|
| 1 | 1 | 0 | 0 | 1 | 1 | 0 | 0 | V_{d1c+} V_{dc2} | magnetization |
| 1 | 1 | 0 | 0 | 0 | 1 | 0 | 0 | V_{dc1} | |
| 0 | 1 | 0 | 0 | 1 | 1 | 0 | 0 | V_{dc2} | |
| 0 | 1 | 0 | 0 | 0 | 1 | 0 | 0 | 0 | Freewheeling |
| 1 | 1 | 0 | 0 | 0 | 0 | 0 | 0 | 0 | |
| 0 | 1 | 0 | 0 | 0 | 0 | 0 | 0 | −V_{dc2} | Demagnetization |
| 0 | 0 | 0 | 0 | 0 | 1 | 0 | 0 | −V_{dc1} | |
| 0 | 0 | 0 | 0 | 0 | 0 | 0 | 0 | −V_{d1c-} V_{dc2} | |

As shown in Table I, the magnetization is achieved when the first switch 815a (S11) of the first cell 820a, the second switch 815b (S12) of the first cell 820a, the first switch 817a (S21) of the second cell 820b and the second switch 817b (S22) of the second cell 820b are closed, and in this configuration the output phase voltage is the sum of the DC-link voltages of the first cell 810a and the second cell 810b. Reduced voltage magnetization modes may also be obtained by selectively deactivating either the first switch 815a (S11) of the first cell 820a, in which case the output phase voltage is equal to the DC-link voltage of the second cell 820b, or the first switch 817a (S21) of the second cell 820b, in which case the output phase voltage is equal to the DC-link voltage of the first cell 820a.

Freewheeling is realized when the second switch 815b (S12) of the first cell 820a and the second switch 817b (S22) of the second cell 820b remain on while the remaining switches are turned off, thereby clamping the phase voltage to approximately zero. Freewheeling is also realized when the first switch 815a (S11) and the second switch 815b (S12) of the first cell 820a remain on while the remaining switches are turned off, in which case also the output phase voltage is approximately zero.

Demagnetization is produced by selectively deactivating all the switches except the second switch 815b (S12) of the first cell 820a, in which case a negative phase voltage of −V_{dc2} results. Demagnetization is also produced by selectively deactivating all the switches except the second switch 817b (S22) of the second cell 820b, in which case a negative phase voltage of −V_{dc1} results. In addition, when all the switches are turned off, the negative phase voltage of −V_{d1c}−V_{dc2} results.

Table II shows an example switching table for the converter topology 800 of FIG. 8 for one phase leg (e.g., Phase A), in accordance with another example embodiment. Table II shows the switching states for the fault-tolerant operation of converter 800.

TABLE II
Switching table for the proposed CHB converter
when current flowing in negative direction

| S₁₁ | S₁₂ | S₁₃ | S₁₄ | S₂₁ | S₂₂ | S₂₃ | S₂₄ | Vₚₕ | Working mode |
|---|---|---|---|---|---|---|---|---|---|
| 0 | 0 | 1 | 1 | 0 | 0 | 1 | 1 | V_{d1c+} V_{dc2} | magnetization |
| 0 | 0 | 1 | 1 | 0 | 0 | 0 | 1 | V_{dc1} | |
| 0 | 0 | 0 | 1 | 0 | 0 | 1 | 1 | V_{dc2} | |
| 0 | 0 | 0 | 1 | 0 | 0 | 0 | 1 | 0 | Freewheeling |
| 0 | 0 | 1 | 1 | 0 | 0 | 0 | 0 | 0 | |
| 0 | 0 | 0 | 1 | 0 | 0 | 0 | 0 | −V_{dc2} | Demagnetization |
| 0 | 0 | 0 | 0 | 0 | 0 | 0 | 1 | −V_{dc1} | |
| 0 | 0 | 0 | 0 | 0 | 0 | 0 | 0 | −V_{d1c-} V_{dc2} | |

As shown in Table II, the magnetization is achieved when the third switch 815c (S13) of the first cell 820a, the fourth switch 815d (S14) of the first cell 820a, the third switch 817c (S23) of the second cell 820b and the fourth switch 817d (S23) of the second cell 820b are closed, and in this configuration the output phase voltage is the sum of the DC-link voltages of the first cell 810a and the second cell 810b.

Reduced voltage magnetization modes may also be obtained by selectively deactivating either the third switch 815c (S13) of the first cell 820a, in which case the output phase voltage is equal to the DC-link voltage of the second cell 820b, or the third switch 817c (S23) of the second cell 820b, in which case the output phase voltage is equal to the DC-link voltage of the first cell 820a.

Freewheeling is realized when the fourth switch 815d (S14) of the first cell 820a and the fourth switch 817d (S24) of the second cell 820b remain on while the remaining switches are turned off, thereby clamping the phase voltage to approximately zero. Freewheeling is also realized when the third switch 815c (S13) and the fourth switch 815d (S14) of the first cell 820a remain on while the remaining switches are turned off, in which case also the output phase voltage is approximately zero.

Demagnetization is produced by selectively deactivating all the switches except the fourth switch 815d (S14) of the first cell 820a, in which case a negative phase voltage of −V_{dc2} results. Demagnetization is also produced by selectively deactivating all the switches except the fourth switch 817d (S24) of the second cell 820b, in which case a negative phase voltage of −V_{dc1} results. In addition, when all the switches are turned off, the negative phase voltage of −V_{d1c}−V_{dc2} results.

Under normal operation, the switching states shown in Tables I and II can be used alternatively in two consecutive conduction periods to make full use of the power switches. Under failure situation in a power switch, either table I or table II can be employed to achieve post-fault operation. In addition, the current paths during magnetization, freewheeling, and demagnetization intervals, including current paths under failure conditions, are illustrated in FIG. 8. Among the available switching states, high magnetization and demagnetization states can be selected near and above the rated conditions. While at low operating conditions, the DC-link voltage V_{dc} and −V_{dc} could give better performance in terms of torque ripple, noise, and voltage stress.

### Shared-Cell CHB Topology for Four-Phase MV SRMs

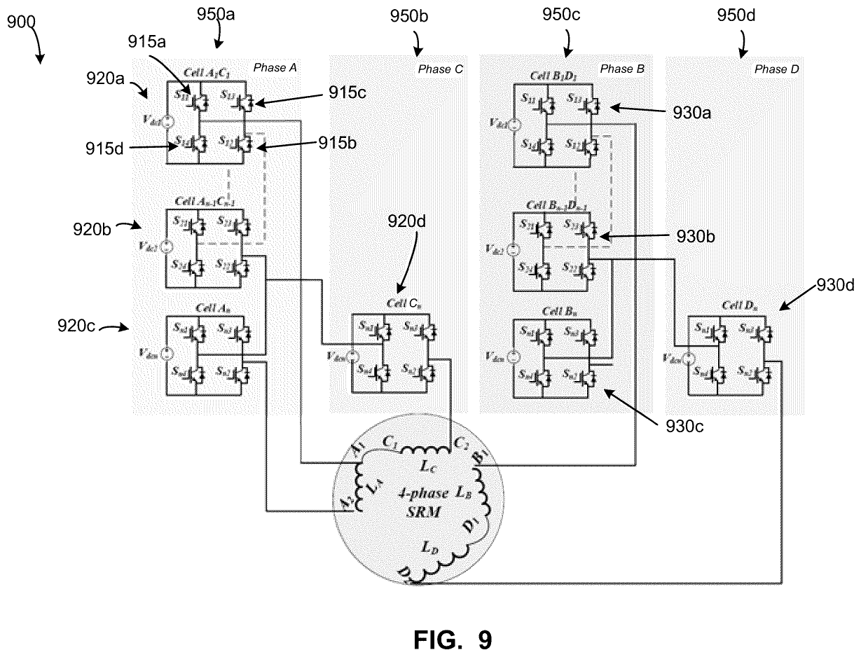

Reference is made to FIG. 9, which illustrates a block diagram of a power converter 900 for a SRM drive in accordance with an example embodiment. In the illustrated embodiment, power converter 900 shows a CHB topology for a four-phase MV SRM drive.

In a four-phase SRM, a maximum of two phases are conducted simultaneously during the commutation regions, while two phases are never conducted simultaneously. In the illustrated embodiment, phase A 950a and phase C 950b never conduct simultaneously, while phase B 950c and phase D 950d do not conduct simultaneously.

This feature of a four-phase SRM gives the opportunity to share the power switch without compromising independent operation of the phases. By using this feature of a four-phase SRM, a significantly simplified low cost multilevel CHB based MV SRM drive results, as shown in FIG. 9. For example, phase A 950a and phase C 950b share a plurality of cells, including a first cell 920a (A₁C₁) and a second cell 920b (Aₙ₋₁Cₙ₋₁). Phase A 950a further comprises a third cell 920c (Aₙ). Phase C 950b further comprises a fourth cell 920d (Cₙ). Similarly, phase B 950c and phase D 950d share a plurality of cells, including a first cell 930a (B₁D₁) and a second cell 930b (Bₙ₋₁Dₙ₋₁). Phase B 950c further comprises a third cell 930c (Bₙ). Phase D 950d further comprises a fourth cell 930d (Dₙ).

Similar to the CHB topology shown in FIG. 4, 2n+1-levels are achieved with n−1 shared cells among two phases. As shown, each single cell contains a four-pack switch module. For example, cell 920a comprises a first power switch 915a (S11), a second power switch 915b (S12), a third power switch 915c (S13) and a fourth power switch 915d (S14).

Multilevel voltages can be generated by cascading the shared power cells between phase A 950a and C 950b and phase B 950c and D 950d. In order to achieve independent operation of each phase, two diagonal switches, such as the first power switch 915a (S11) and the second power switch 915b (S12) are turned on for current control in one phase, while the third power switch 915c (S13) and the fourth power switch 915d (S14) are used for phase current regulation in another phase.

A comparison of components counts between the standard and the shared-cell topology is presented in Table III.

TABLE III
COMPARISON ON COMPONENT COUNTS

| | 5- | 7- | 9 | 11 | 13 |
|---|---|---|---|---|---|
| Indices | Level | level | level | level | level |
| Switches in Conventional | 32 | 48 | 64 | 80 | 96 |
| topology | | | | | |
| Switches in proposed topology | 24 | 32 | 40 | 48 | 56 |
| Switch count reduction | 8 | 16 | 24 | 32 | 40 |
| DC-sources in Conventional | 8 | 12 | 16 | 20 | 24 |
| DC sources in Proposed | 5 | 7 | 9 | 11 | 13 |
| MV SRMs | | | | | |
| Dc-source reduction | 3 | 5 | 7 | 9 | 11 |

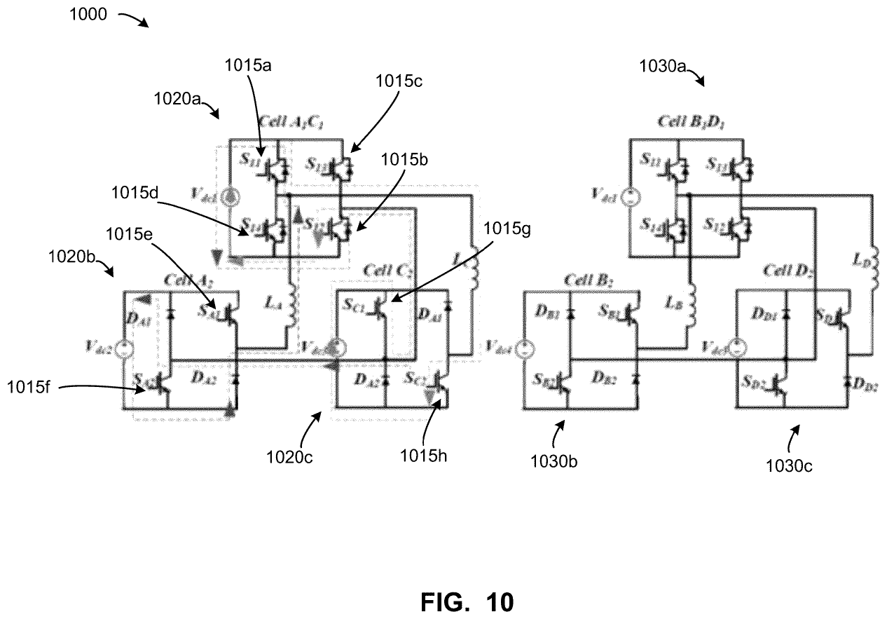

Reference is made to FIG. 10, which illustrates a block diagram of a converter 1000 in accordance with an example embodiment. Converter 1000 comprises a 5-level CHB topology with shared cells among two phases. In particular, converter 1000 comprises a first shared cell 1020a (A₁C₁), which is shared between phase A and phase C. Converter 1000 further comprises a second cell 1020b (A₂) in phase A and a third cell 1020c (C₂) in phase C. Similarly, converter 1000 comprises a first shared cell 1030a (B₁D₁), which is shared between phase B and phase D. Converter 1000 further comprises a second cell 1030b (B₂) in phase B and a third cell 1030c (D₂) in phase D.

In the illustrated embodiment, each shared cell, such as cell 1020a and cell 1030a comprises a four-switch module. For example, cell 1020a comprises a first power switch 1015a (S11), a second power switch 1015b (S12), a third power switch 1015c (S13) and a fourth power switch 1015d (S14).

The other cells, such as cells 1020b, 1020c, 1030b and 1030c may be built based on an either H-bridge or a chopper module with a power switch and a diode. For example, cell 1020b comprises a module comprises a first power switch 1015e (S_{A1}) and a second power switch 1015f (S_{A2}). Similarly, cell 1020c comprises a first power switch 1015g (S_{C1}) and a second power switch 1015h (S_{C2}). The current paths showing the simultaneous magnetization and demagnetization of the shared phases are shown in FIG. 10.

The switching states, output voltage, and the corresponding working modes for the five-level topology are illustrated in Tables IV and V. Among the shared phases, Table IV shows the switching modes for phase A and Table V shows the working modes for phase C. Same tables can be used for phase B and D.

TABLE IV
Switching table for the five-level CHB topology
1000 considering phase A excitation

| Modes | S₁₃ | S₁₄ | S_{A1} | S_{A2} | Vₚₕ | Working mode |
|---|---|---|---|---|---|---|
| 1 | 1 | 1 | 1 | 1 | V_{dc1} + V_{dc2} | magnetization |
| 2 | 1 | 1 | 1 | 0 | V_{dc1} | |
| 3 | 1 | 0 | 1 | 1 | V_{dc2} | |
| 4 | 1 | 0 | 1 | 0 | 0 | Freewheeling |
| 5 | 0 | 1 | 0 | 1 | 0 | |
| 6 | 0 | 0 | 0 | 0 | −(V_{dc1} + V_{dc2}) | Demagnetization |
| 7 | 0 | 0 | 0 | 1 | −V_{dc1} | |
| 8 | 0 | 1 | 0 | 0 | −V_{dc2} | |
| 9 | 1 | 0 | 0 | 0 | −V_{dc2} | |

As shown in Table IV, the magnetization is achieved when the third switch 1015c (S13) of the first cell 1020a, the fourth switch 1015d (S14) of the first cell 1020a, the first switch 1015e (S_{A1}) of the second cell 1020b and the second switch 1015f (S_{A2}) of the second cell 1020b are closed, and in this configuration the output phase voltage is the sum of the DC-link voltages of the first cell 1020a and the second cell 1020b. Reduced voltage magnetization modes may also be obtained by selectively deactivating either the second switch 1015f (S_{A2}) of the second cell 1020b, in which case the output phase voltage is equal to the DC-link voltage of the first cell 1020a, or the fourth switch 1015d (S14) of the first cell 1020a, in which case the output phase voltage is equal to the DC-link voltage of the second cell 1020b.

Freewheeling is realized when the third switch 1015c (S13) of the first cell 1020a and the first switch 1015e (S_{A1}) of the second cell 1020b remain on while the remaining switches are turned off, thereby clamping the phase voltage to approximately zero. Freewheeling is also realized when the fourth switch 1015d (S14) of the first cell 1020a and the second switch 1015f (S_{A2}) of the second cell 1020b remain on while the remaining switches are turned off, in which case also the output phase voltage is approximately zero.

Demagnetization is produced by selectively deactivating all the switches, in which case the negative phase voltage of −(V_{d1c}+V_{dc2}) results. Demagnetization is also produced by selectively deactivating all the switches except the second switch 1015f (S_{A2}) of the second cell 1020b, in which case a negative phase voltage of −V_{dc1} results. In another mode, demagnetization is realized by selectively deactivating all the switches except the fourth switch 1015d (S14) of the first cell 1020a, in which case a negative phase voltage of −V_{dc2} results. Similarly, demagnetization is realized by selectively deactivating all the switches except the third switch 1015c (S13) of the first cell 1020a, in which case a negative phase voltage of −V_{dc2} results.

Reference is next made to Table V, which shows the working modes for phase C.

TABLE V
Switching table for the five-level CHB topology
1000 considering phase C excitation

| Modes | S₁₁ | S₁₂ | S_{C1} | S_{C2} | Vₚₕ | Working mode |
|---|---|---|---|---|---|---|
| 1 | 1 | 1 | 1 | 1 | V_{dc1} + V_{dc3} | magnetization |
| 2 | 1 | 1 | 1 | 0 | V_{dc1} | |
| 3 | 1 | 0 | 1 | 1 | V_{dc3} | |
| 4 | 1 | 0 | 1 | 0 | 0 | Freewheeling |
| 5 | 0 | 1 | 0 | 1 | 0 | |
| 6 | 0 | 0 | 0 | 0 | −(V_{dc1} + V_{dc3}) | Demagnetization |
| 7 | 0 | 0 | 0 | 1 | −V_{dc1} | |
| 8 | 0 | 1 | 0 | 0 | −V_{dc3} | |
| 9 | 1 | 0 | 0 | 0 | −V_{dc3} | |

As shown in Table V, the magnetization is achieved when the first switch 1015a (S11) of the first cell 1020a, the second switch 1015b (S12) of the first cell 1020a, the first switch 1015g (S_{C1}) of the third cell 1020c and the second switch 1015h (S_{C2}) of the third cell 1020c are closed, and in this configuration the output phase voltage is the sum of the DC-link voltages of the first cell 1020a and the third cell 1020c. Reduced voltage magnetization modes may also be obtained by selectively deactivating either the second switch 1015h (S_{C2}) of the third cell 1020c, in which case the output phase voltage is equal to the DC-link voltage of the first cell 1020a, or the second switch 1015b (S12) of the first cell 1020a, in which case the output phase voltage is equal to the DC-link voltage of the third cell 1020c.

Freewheeling is realized when the first switch 1015a (S11) of the first cell 1020a and the first switch 1015g (S_{C1}) of the third cell 1020c remain on while the remaining switches are turned off, thereby clamping the phase voltage to approximately zero. Freewheeling is also realized when the second switch 1015b (S12) of the first cell 1020a and the second switch 1015h (S_{C2}) of the third cell 1020c remain on while the remaining switches are turned off, in which case also the output phase voltage is approximately zero.

Demagnetization is produced by selectively deactivating all the switches, in which case the negative phase voltage of −(V_{d1c}+V_{dc3}) results. Demagnetization is also produced by selectively deactivating all the switches except the second switch 1015h (S_{C2}) of the third cell 1020c, in which case a negative phase voltage of −V_{dc1} results. In another mode, demagnetization is realized by selectively deactivating all the switches except the second switch 1015b (S12) of the first cell 1020a, in which case a negative phase voltage of −V_{dc3} results. Similarly, demagnetization is realized by selectively deactivating all the switches except the first switch 1015a (S11) of the first cell 1020a, in which case a negative phase voltage of −V_{dc3} results.

### Simulation Verifications

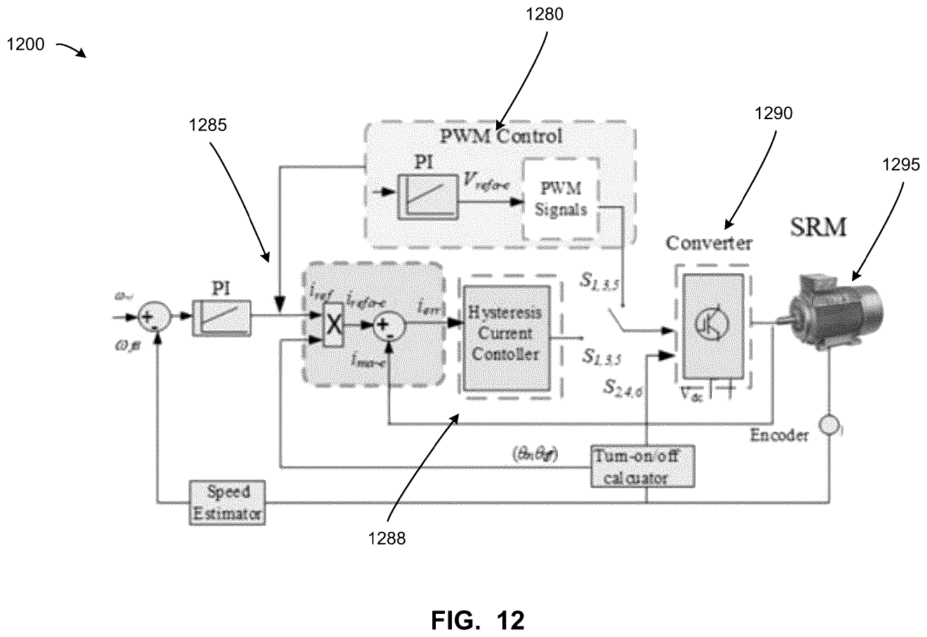

Reference is next made to FIG. 12, which illustrates a physical prototype 1200, in accordance with an example embodiment, for testing the various topologies disclosed herein. Prototype 1200 includes a SRM 1295, a SRM drive system 1290, a current control system 1285 including a hysteresis current controller 1288 and a pulse width modulation (PWM) controller 1280. The parameters of the SRM drive system 1290, which is a CHB fed MV SRM drive, are given in Table VI. The drive system 1290 is controlled using typical current chopping control schemes shown in FIG. 12. Simulations were performed under both steady state and dynamic conditions. The dc-link voltage of each cell was 1000V.

### Parameters Model

TABLE VI
of SRM

| Parameters | Values | |
|---|---|---|
| Power | 650 | kW |
| Cell Voltage | 1000 | V |
| Speed | 1200 | rpm |
| Load torque | 5173 | Nm |

| | |
|---|---|
| Number cells | 2 |
| Voltage level | 5 |

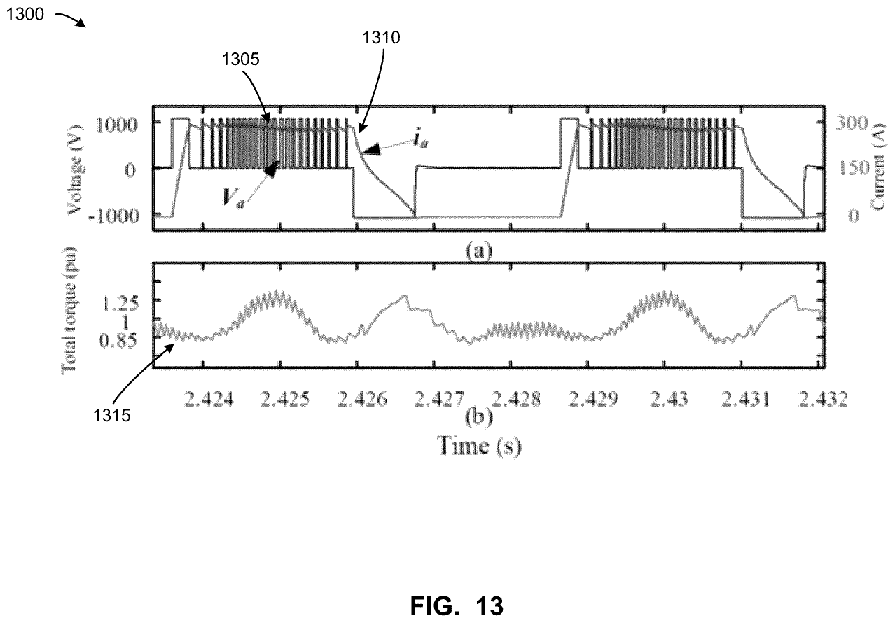

Reference is made to FIG. 13, which illustrates example Parameters model waveforms 1300 for a converter topology under normal condition at 600 rpm, in accordance with an example embodiment. FIG. 13 shows an example phase voltage (V) waveform 1305, a phase current (A) waveform 1310, and a total torque (Nm) waveform 1315, of the SRM under steady state operation with the rated torque (presented in per unit) under half of the rated speed. In this case, only V_{dc} was applied across the phase and the motor was controlled using the current chopping control (CCC) scheme shown in FIG. 12.

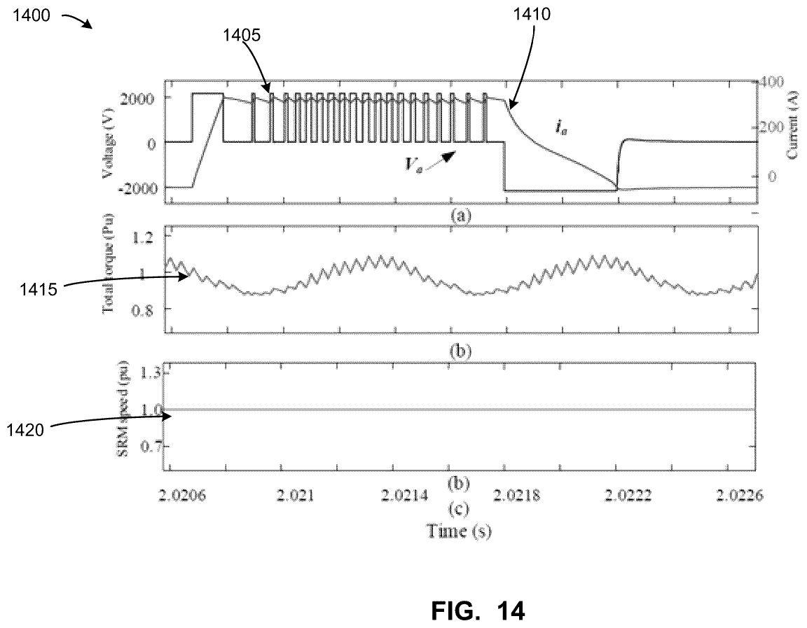

Reference is made to FIG. 14, which illustrates example simulation waveforms 1400 for a converter topology in accordance with an example embodiment. FIG. 14 shows an example phase voltage (V) waveform 1405, a phase current (A) waveform 1410, and a total torque (Nm) waveform 1415, and an operating speed (rpm) waveform 1420 of the SRM. In this embodiment, 2V_{dc} was applied under the same rated speed condition. As shown by speed waveform 1420, the motor was well controlled, and the current was perfectly following the reference current. This is mainly because the increased dc-link voltage suppressed the back EMF and injected more current into the phase. This phenomenon confirms that with the increasing voltage levels, the torque-speed range can be significantly increased making the SRM feasible for very high-speed applications.

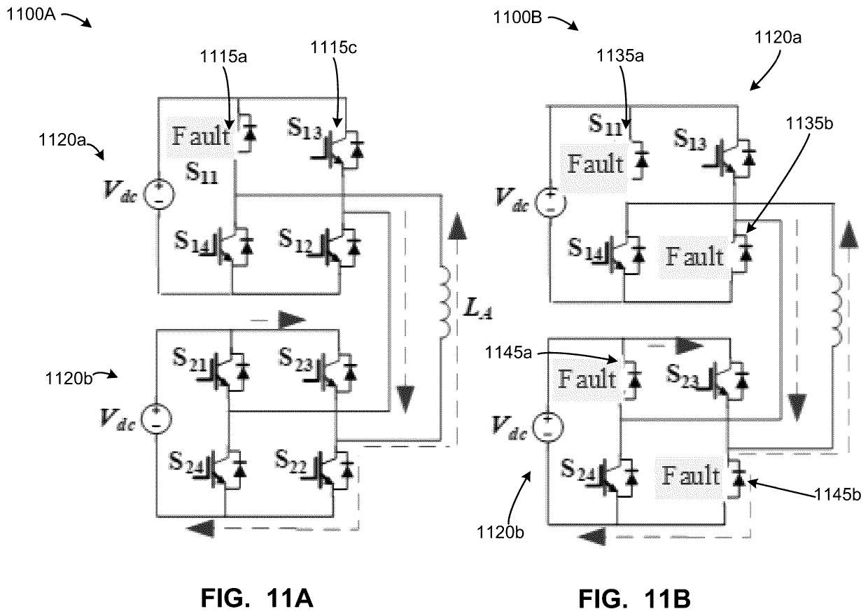

Reference is made to FIG. 11A, which illustrates a block diagram of a converter 1100A in accordance with an example embodiment. In particular, converter 1100A shows an example of a converter under fault tolerant conditions. Converter 1100A comprises a first cell 1120a and a second cell 1120b in the phase leg for phase A. In the illustrated example, an open-circuit fault appears in any diagonal switch of phase A in any cell, and in such examples, the direction of the current is simply shifted to other side, as discussed above. For instance, if an open-circuit fault occurs in the first switch 1115a (S11) of the first cell 1120a, the current direction is reversed by shifting the switching signal to the third switch 1115c (S13) of the first cell 1120a.

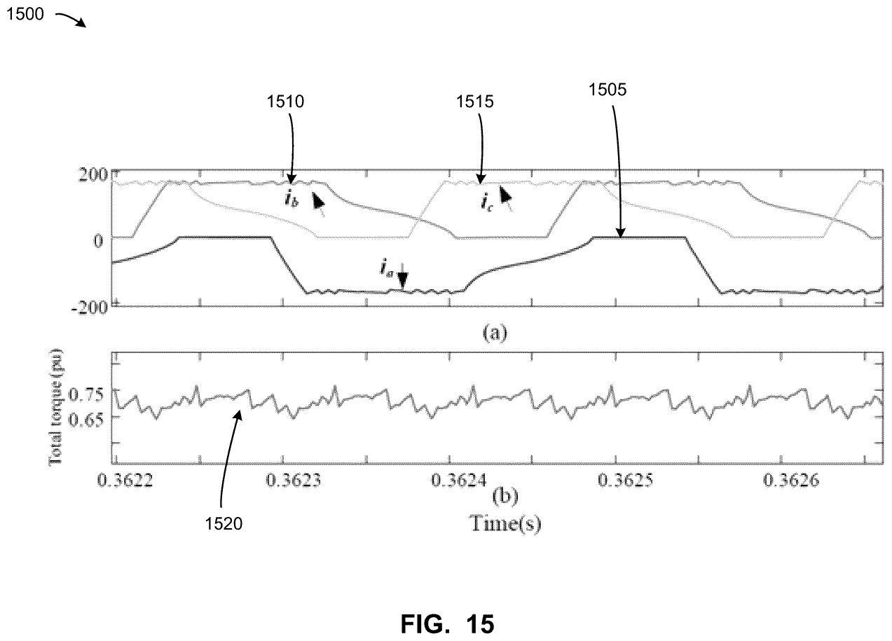

Reference is made to FIG. 15, which illustrates example simulation waveforms 1500 for a converter topology in accordance with an example embodiment. In particular, waveforms 1500 show the simulation results for a test conducted on the converter 1100A of FIG. 11A. FIG. 15 shows an example current waveform for phase A 1505, a current waveform for phase B 1510 and a current waveform for phase C 1515. As seen, phase A current 1505 is in the reverse direction, while phase B current 1510 and phase C current 1515 are in the same direction. Waveform 1520 shows the total torque, and as can be seen, the total torque shows no effect due to this reverse direction and the motor is working perfectly at the reference speed.

Reference is made to FIG. 11B, which illustrates a block diagram of a converter 1100B in accordance with an example embodiment. In particular, converter 1100B shows an example of a converter under fault tolerant conditions. Converter 1100B comprises a first cell 1120a and a second cell 1120b in the phase leg for phase A. In this example, a fault occurs in all phases. For instance, a fault occurs in the first switch 1135a (S11) and the second switch 1135b (S12) of the first cell 1120a, and the first switch 1145a (S21) and the second switch 1145b (S22) of the second cell 1120b.

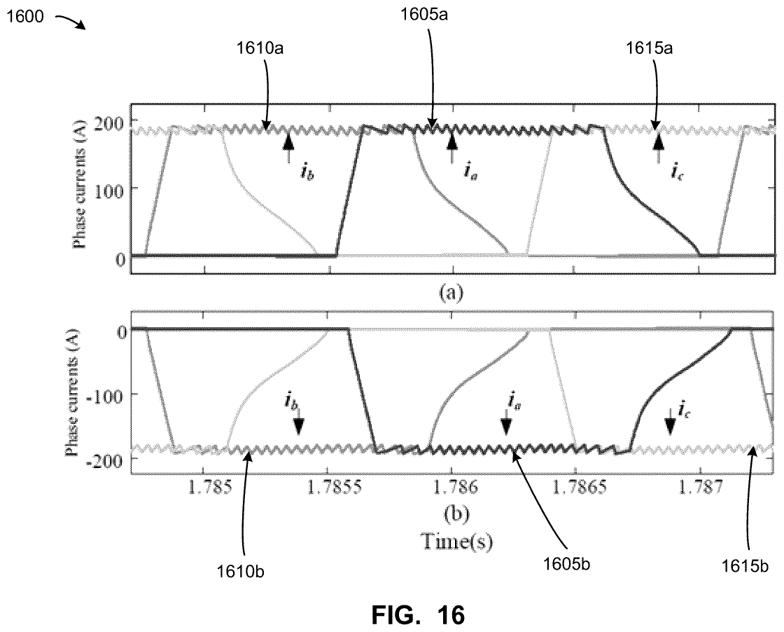

Reference is made to FIG. 16, which illustrates example simulation waveforms 1600 for a converter topology in accordance with an example embodiment. In particular, waveforms 1600 show the simulation results for a test conducted on the converter 1100B of FIG. 11B, where faults are introduced in all the phases. Waveforms 1605a and 1605b show the positive and negative current waveforms for phase A, waveforms 1610a and 1610b show the positive and negative current waveforms for phase B, and waveforms 1615a and 1615b show the positive and negative current waveforms for phase C. The waveforms 1605a, 1610a and 1615a correspond to normal SRM operation with positive currents, and waveforms 1605b, 1610b and 1615b correspond to SRM operation under faulty condition with negative currents.

As seen in FIG. 16, by leveraging the bidirectional current-flow capability of the proposed topology, the faults were effectively mitigated and the SRM system continued to operate in a manner similar to normal conditions. In the event of a short circuit in a power switch (e.g., the first switch 1135a (S11) of the first cell 1120a), the affected power cell enters a freewheeling state, and voltage levels of 2V_{dc} and −2V_{dc} cannot be applied across the faulty phase. Nevertheless, the motor can still be driven using V_{dc} and −V_{dc}. In the case of a dual-switch short-circuit fault, a fuse-cutout mechanism may be employed to convert the short-circuit condition into an open-circuit fault and a similar procedure can be carried out to continue the drive operation.

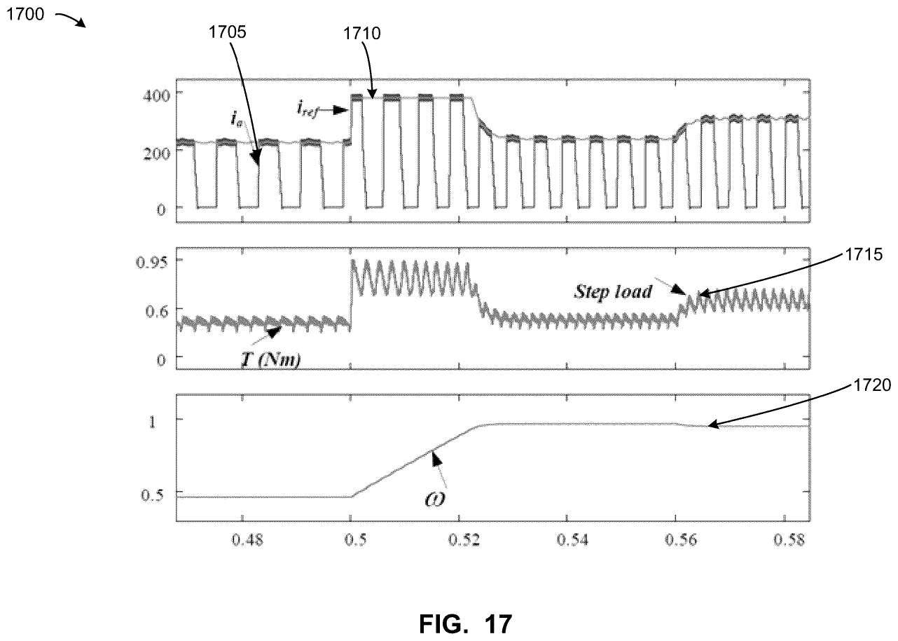

Reference is made to FIG. 17, which illustrates example simulation waveforms 1700 for a converter topology in accordance with an example embodiment. In particular, waveforms 1700 show the simulation results for a test performed on a converter under dynamic operating conditions, including the introduction of a step change in speed and load. Waveform 1705 shows the current (A) waveform for phase A, waveform 1710 shows the reference current for phase A, waveform 1715 shows the total torque (Nm) and waveform 1720 shows the operating speed (rpm) of the motor.

As seen, the motor reached the steady state operating point quickly after the step change, and no significant speed fluctuations were observed under the step load change. These results demonstrate that the proposed control approach maintains stable and reliable operation under dynamic conditions.

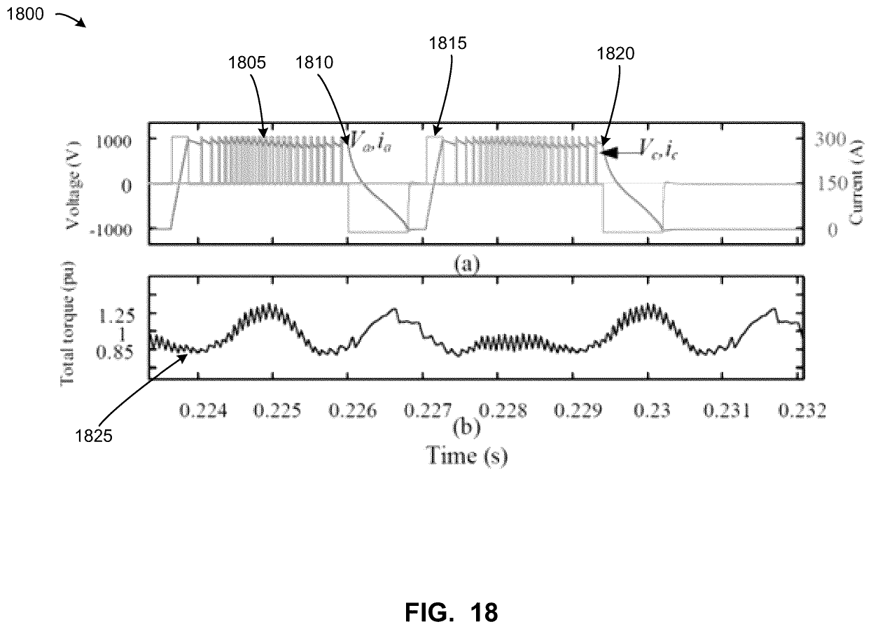

Reference is made to FIG. 18, which illustrates example simulation waveforms 1800 for a converter topology in accordance with an example embodiment. In particular, waveforms 1800 show the simulation results for a test conducted on a converter, such as, for example, the shared-cell CHB converter 900 of FIG. 9. Waveform 1805 shows the phase voltage (V) of phase A and waveform 1810 shows the phase current (A) of phase A. Waveform 1815 shows the phase voltage (V) of phase C and the waveform 1820 shows the phase current (A) of phase C. Waveform 1825 shows the total torque (Nm) of the SRM.

FIG. 18 shows the phase currents and phase voltages of the shared phases (phase A and phase C) in a fundamental current period. As can be seen, the motor is working under the rated torque (presented in per unit) under at half of the rated speed. In this case, switching modes 2 and 7 from Table IV and V were adopted for magnetization and demagnetization of the phases. It is very clear that both the shared phases were independently controlled and could achieve magnetization in one phase and demagnetization in another phase simultaneously.

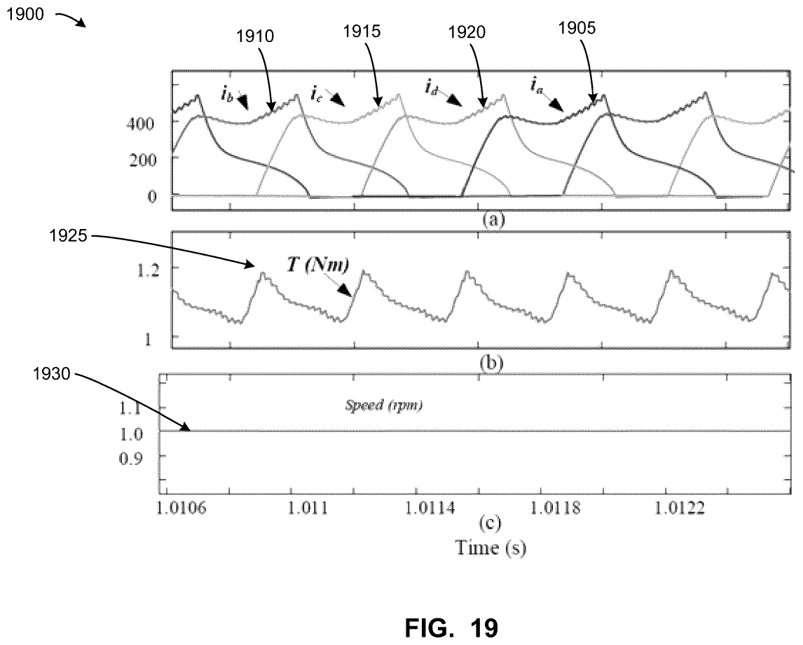

Reference is made to FIG. 19, which illustrates example simulation waveforms 1900 for a converter topology in accordance with an example embodiment. In particular, waveforms 1900 show the simulation results for a test conducted on a converter, such as, for example, the shared-cell CHB converter 900 of FIG. 9. Waveform 1905 shows the phase current of phase A, waveform 1910 shows the phase current of phase B, waveform 1915 shows the phase current of phase C and waveform 1920 shows the phase current of phase D. Waveform 1925 shows the instantaneous torque (Nm). Waveform 1930 shows the rotational speed (rpm) of the motor.

FIG. 19 shows the four-phase currents and total instantaneous torque at the rated speed under half dc-link voltage applied by selecting the switching modes 2, 4 and 7 in Table IV and V. It can be observed that under rated conditions, the dc-link voltage becomes less sufficient to inject current into the phases and thus produce more ripples in the torque. The presented waveforms demonstrate that the proposed CHB topology has significant advantages in improving the performance of the drive system by offering multilevel voltage selection capabilities under different operating conditions. The topology enables the SRM to be used in medium voltage applications and also helps in improving system level performance in low voltage applications.

SRMs are considered a cost-effective alternative to other AC machines for low to medium voltage applications, primarily due to their simple and rare-earth free configuration. However, their usage in MV applications typically above 2.3 kV has not received much attention due to the performance limitations of the existing power converters. By addressing this important challenge, firstly, an approach of utilizing cascaded H-bridge (CHB) converters for MV SRM drives is disclosed herein. Then, optimizing the cost associated with the CHB based MV SRMs, another cost-effective topology suitable for a four-phase MV SRM is disclosed herein. The control, and performance analysis under steady state and dynamic conditions confirmed the feasibility of both newly developed topologies for effective utilization in wide range MV applications. The topologies offer several advantages, particularly in terms of modularity, scalability, and fault-tolerance. It can scale up to 13.8 kV output voltage, making it suitable for a wide range of MV industrial applications. For multiphase MV SRMs, more legs can be added according to the number of phases. Compared to the traditional MV motor drives, the utilization of CHB converters in SRMs brings additional advantages including cost-effectiveness, high reliability, high operating temperature, and wide torque-speed range. The disclosed embodiments, thus, opens up new possibilities for incorporating SRMs in heavy industries, extending the benefits of SRMs beyond low voltage applications.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

### CITATIONS

J. Ahn and G. F. Lukman, “Switched reluctance motor: Research trends and overview,” in CES Transactions on Electrical Machines and Systems, vol. 2, no. 4, pp. 339-347, December 2018, doi: 10.30941/CESTEMS.2018.00043.
E. Bostanci, M. Moallem, A. Parsapour and B. Fahimi, “Opportunities and challenges of switched reluctance motor drives for electric propulsion: A comparative study,” in IEEE Transactions on Transportation Electrification, vol. 3, no. 1, pp. 58-75, March 2017.
N. Ali, Q. Wang, Q. Gao and K. Ma, “Single-Sensor Based Low-Cost Current Control in SRM Drives for Electric Vehicle Applications,” 2022 IEEE Transportation Electrification Conference and Expo, Asia-Pacific (ITEC Asia-Pacific), Haining, China, 2022, pp. 1-5
Krishnan R. Switched reluctance motor drives: modeling, simulation, analysis, design, and applications. CRC press; 2017 Dec. 19.

M. A. Gaafar, A. Abdelmaksoud, M. Orabi, H. Chen and M. Dardeer, “Switched Reluctance Motor Converters for Electric Vehicles Applications: Comparative Review,” in IEEE Transactions on Transportation Electrification, 2022, doi: 10.1109/TTE.2022.3192429.
O. Kilic, A. Topcu, M. E. Haque, and Y. Sozer, “A New Converter Topology for Switched Reluctance Machines to Improve High-Speed Performance,” in 2019 IEEE Transportation Electrification Conference and Expo (ITEC), Detroit, MI, USA, June 2019, pp. 1-5, doi: 10.1109/ITEC.2019.8790526.
Jianing Liang, Dong-Hee Lee, Guoqing Xu, and Jin-Woo Ahn, “Analysis of Passive Boost Power Converter for Three-Phase SR Drive,” IEEE Trans. Ind. Electron., vol. 57, no. 9, pp. 2961-2971 September 2010, doi: 10.1109/TIE.2010.2040558.
W. Ding, S. Yang, and Y. Hu, “Performance Improvement for Segmented-Stator Hybrid-Excitation SRM Drives Using an Improved Asymmetric Half-Bridge Converter,” IEEE Trans. Ind. Electron., vol. 66, no. 2, pp. 898-909, February 2019, doi: 10.1109/TIE.2018.2833034.
W. Ding, S. Yang, and Y. Hu, “A novel boost converter for segmented-stator hybrid-excitation switched reluctance motor drive with high performance,” in 2018 IEEE Applied Power Electronics Conference and Exposition (APEC), San Antonio, TX, USA, March 2018, pp. 1223-1228, doi: 10.1109/APEC.2018.8341172.
C. Peng, S. Song, R. Ma, and W. Liu, “A novel modular 4-level power converter-based direct instantaneous torque control strategy for switched reluctance machine,” in 2018 13th IEEE Conference on Industrial Electronics and Applications (ICIEA), Wuhan, May 2018, pp. 2079-2083, doi: 10.1109/ICIEA.2018.8398052.
S. Song, C. Peng, Z. Guo, R. Ma, and W. Liu, “Direct Instantaneous Torque Control of Switched Reluctance Machine Based on Modular Multi-Level Power Converter,” in 2019 22nd International Conference on Electrical Machines and Systems (ICEMS), Harbin, China, August 2019, pp. 1-6, doi: 10.1109/ICEMS.2019.8921814.
G. Han and H. Chen, “Improved Power Converter of SRM Drive for Electric Vehicle with Self-Balanced Capacitor Voltages,” in IEEE Transactions on Transportation Electrification, vol. 7, no. 3, pp. 1339-1348 September 2021, doi: 10.1109/TTE.2020.3037111.
J. Rodriguez, S. Bernet, B. Wu, J. O. Pontt and S. Kouro, “Multilevel Voltage-Source-Converter Topologies for Industrial Medium-Voltage Drives,” in IEEE Transactions on Industrial Electronics, vol. 54, no. 6, pp. 2930-2945 December 2007, doi: 10.1109/TIE.2007.907044.
W. C. Rossmann and R. G. Ellis, “Retrofit of 22 pipeline pumping stations with 3000-hp motors and variable-frequency drives,” IEEE Trans. Ind. Appl., vol. 34, no. 1, pp. 178-186, January/February 1998.
R. Menz and F. Opprecht, “Replacement of a wound rotor motor with an adjustable speed drive for a 1400 KW kiln exhaust gas fan,” in Proc. 44th IEEE IAS Cement Ind. Tech. Conf., 2002, pp. 85-93.
B. P. Schmitt and R. Sommer, “Retrofit of fixed speed induction motors with medium voltage drive converters using NPC three-level inverter high voltage IGBT based topology,” in Proc. IEEE Int. Symp. Ind. Electron., 2001, pp. 746-751.
S. Bernert, “Recent developments of high power converters for industry and traction applications,” IEEE Trans. Power Electron., vol. 15, no. 6, pp. 1102-1117 November 2000. [8] H. Okayama, M. Koyama et al., “Large capacity high performance 3-level GTO inverter system for steel main rolling mill drives,” in Conf. Rec. IAS Annu. Meeting, 1996, pp. 174-179.
J. M. Carrasco, L. G. Franquelo, J. T. Bialasiewicz, E. Galvan, R. C. Portillo Guisado, M. A. M. Prats, J. I. Leon, and N. Moreno-Alfonso, “Power-electronic systems for the grid integration of renewable energy sources: A survey,” IEEE Trans. Ind. Electron., vol. 53, no. 4, pp. 1002-116 June 2006.
S. Alepuz, S. Busquets-Monge, J. Bordonau, J. Gago, D. Gonzalez, and J. Balcells, “Interfacing renewable energy sources to the utility grid using a three-level inverter,” IEEE Trans. Ind. Electron., vol. 53, no. 5, pp. 1504-1511 October 2006.
]R. C. Portillo, M. M. Prats, J. I. Leon, J. A. Sanchez, J. M. Carrasco, E. Galvan, and L. G. Franquelo, “Modeling strategy for back-to-back three-level converters applied to high-power wind turbines,” IEEE Trans. Ind. Electron., vol. 53, no. 5, pp. 1483-1491 October 2006.
A. Nabae, I. Takahashi, and H. Akagi, “A new neutral-point-clamped PWM inverter,” IEEE Trans. Ind. Appl., vol. IA-17, no. 5, pp. 518-523, September/October 1981.
T. Meynard and H. Foch, “Multi-level choppers for high voltage applications,” Eur. Power Electron. J., vol. 2, no. 1, pp. 45-50, March 1992.
M. Marchesoni, M. Mazzucchelli, and S. Tenconi, “A non-conventional power converter for plasma stabilization,” in Proc. Power Electron. Spec. Conf., 1988, pp. 122-129.

1. A cascaded H-bridge (CHB) converter system for driving a switched reluctance motor (SRM), the SRM comprising a predetermined number of phases (m), the system comprising:
a plurality of cells arranged into m phase legs, where each phase leg comprises a predetermined number (n) of cells cascaded in series, where n is greater than or equal to 1, and wherein each phase leg corresponds to a respective phase winding of the SRM;
each cell comprising a plurality of switching elements and a corresponding DC voltage supply; and
a controller configured to selectively control the switching elements of the cascaded cells of each phase leg to produce, at an output of the corresponding phase leg, a plurality of discrete phase voltage levels for operating the SRM in a plurality of operating modes, wherein the number of discrete phase voltage levels provided by each phase leg equals 2n+1.

2. The system of claim 1, wherein each cell comprises four switching elements arranged as a full H-bridge.

3. The system of claim 1, wherein each cell comprises two diodes and two switching elements arranged in an asymmetric half-bridge (AHB) configuration.

4. The system of claim 1, wherein when the number of cells, n, per phase is equal to 3, the number of discrete phase voltage levels for each phase is 7.

5. The system of claim 1, wherein when the number of cells, n, per phase is equal to 2, the number of discrete phase voltage levels for each phase is 5.

6. The system of claim 1, wherein the SRM is operable at any voltage level above 2.3 kV.

7. A cascaded H-bridge (CHB) converter system for driving a multi-phase switched reluctance motor (SRM), the SRM comprising a predetermined number of phases (m), the system comprising:
a plurality of cells arranged into m phase legs, each phase leg corresponding to a respective phase winding of the SRM, wherein at least two phase legs share one or more of the cells, wherein the shared cells are associated with phases that are not conducted simultaneously during any commutation interval;
each cell comprising a plurality of switching elements and a corresponding DC voltage supply; and
a controller configured to selectively control the switching elements of the cascaded cells of each phase leg to produce, at an output of the corresponding phase leg, a plurality of discrete phase voltage levels for operating the SRM in a plurality of operating modes, wherein the number of discrete phase voltage levels provided by each phase leg equals 2n+1.

8. The system of claim 7, wherein each cell comprises four switching elements arranged as a full H-bridge.

9. The system of claim 7, wherein each shared cell comprises four switching elements arranged as a full H-bridge, and other cells comprise two diodes and two switching elements arranged in an asymmetric half-bridge (AHB) configuration.

10. The system of claim 7, wherein when the number of shared cells between the at least two phase legs is 2, the total number of cells per phase is equal to 3 and the number of discrete phase voltage levels for each phase is 7.

11. The system of claim 7, wherein when the number of shared cells between the at least two phase legs is 1, the total number of cells per phase is equal to 2 and the number of discrete phase voltage levels for each phase is 5.

12. The system of claim 7, The system of claim 6, wherein the SRM is a four-phase SRM including a first phase, a second phase, a third phase, and a fourth phase, and wherein a first subset of two phase legs, comprising the first phase and the second phase, share one or more cells, and a second subset of two phase legs, comprising the third phase and the fourth phase, share one or more cells.

13. The system of claim 7, wherein the SRM is operable at any voltage level above 2.3 kV.

14. A method of generating a plurality of discrete phase voltage levels for driving a switched reluctance motor (SRM) using a cascaded H-bridge (CHB) converter system, the SRM comprising a predetermined number of phases (m), wherein the system comprises:
a plurality of cells arranged into m phase legs, where each phase leg comprises a predetermined number (n) of cells cascaded in series, where n is greater than or equal to 1, and wherein each phase leg corresponds to a respective phase winding of the SRM;
each cell comprising a plurality of switching elements and a corresponding DC voltage supply; and
a controller coupled to the plurality of cells,
wherein the method comprises:
selectively controlling, using the controller, the switching elements of the cascaded cells of each phase leg; and
generating, at an output of the corresponding phase leg, the plurality of discrete phase voltage levels for operating the SRM in a plurality of operating modes, wherein the number of discrete phase voltage levels provided by each phase leg equals 2n+1.

15. The method of claim 14, wherein each cell comprises four switching elements arranged as a full H-bridge.

16. The method of claim 14, wherein each cell comprises two diodes and two switching elements arranged in an asymmetric half-bridge (AHB) configuration.

17. The method of claim 14, wherein when the number of cells, n, per phase is equal to 3, the method comprises generating seven discrete voltage levels for each phase.

18. The method of claim 14, wherein when the number of cells, n, per phase is equal to 2, the method comprises generating five discrete voltage levels for each phase.
